(19) United States
(12) Patent Application Publication
(10) Pub. No.: US 2006/0086381 A1
(43) Pub. Date: Apr. 27, 2006

(54) Water powered fishing line washing apparatus

(76) Inventor: Armando J. Bardini, Grass Valley, CA (US)

Correspondence Address: Armando J. Bardini, 12033 Hanley Dr., Grass Valley, CA, 95949, US

(21) Appl. No.: 10/961,901

(22) Filed: Oct. 9, 2004

(51) Int. Cl. B08B 3/00

(52) U.S. Cl. 134/144

(57) ABSTRACT

An automatic fishing line washing apparatus is disclosed. The apparatus is structured to be connected to a domestic water source and to be utilized in conjunction with a fishing reel and rod. The fishing line is automatically washed by allowing the fishing line to wind onto the apparatus storage reel from the fishing rod and then rewinding the line back onto the fishing rod using the fishing rod reel. The apparatus is comprised of means for domestic water to be directed through a fixed spindle consisting of fluid passage grooves and ports that communicate with aligned holes and hollow posts comprising the said storage reel, thereby allowing the water to be directed to exit holes in the said posts in the hub of the storage reel. The water exits the said hollow posts of the storage reel at a predetermined radius from the rotating axis of the said fixed spindle, thereby providing a reactive force sufficient to unwind the line from the fishing line reel, but not of such magnitude to prevent the line to be rewound onto the fishing rod by the hand operated reel on the rod.

### DISCUSSION OF PRIOR ARTS

A search of reference patents under the classification of fishing line washing or water powered reels and spools and the like, did not result in any reference patents, but patents in the classifications pertaining to fluid powered turbines and rotary engines were numerous. The structural elements comprising the turbines or rotary engines of the reference patents, are different from the structural elements pertaining to this invention and what is claimed in this application.

Four reference patent are cited to illustrate the structural differences. The four patents cited have rotors with a plurality of nozzles, orifices or vanes on the periphery of rotors. The rotors rotate in a housing with the driving fluid exiting the periphery of the rotor and collected in the said housing. The fluid is exhausted to the atmosphere from a fixed exhaust port in the housing. The driving fluid enters into a rotor cavity through a hollow shaft and exits at the periphery of the rotor.

The reference patent numbers are as follows:
1. U.S. Pat. No. 939,046
2. U.S. Pat. No. 1,329,626
3. U.S. Pat. No. 4,178,125
4. U.S. Pat. No. 4,466,245

### BRIEF DISCUSSION OF THE DRAWINGS

FIG. 1 is an isometric drawing showing the principal elements of the apparatus that is the basis of this invention.

FIG. 2 is a sectional view showing a sub assembly of the storage reel and fishing line guide installed and secured onto the spindle.

FIG. 3 is a plan view of the sub assembly shown in FIG. 2 installed on a supporting stand.

FIG. 4 is an isometric view of the parts comprising a tubular supporting stand weldment.

FIG. 5 is an elevation view and illustration showing a fishing line from a fishing rod winding onto a storage reel and being washed by a water spray.

### BACKGROUND OF INVENTION

Professional anglers find it necessary to wash and clean their fishing lines frequently. The primary reasons for cleaning and washing fishing lines is to increase the life of the fishing line, reduce friction in the guides, improve floatation and reduce tangling of the line. Fishing in dirty water, practicing fly casting in the back yard and salt water fishing are some reasons for cleaning fishing lines often. When fishing in salt water, it is important to desalinate the fishing line by frequent rinsing and washing of the fishing line. There are a number of methods used to clean fishing lines, most of these methods are manual and involve unwinding the fishing line from the fishing reel on to storage spools and soaking the spool and fishing line in warm water and soap, then rinsing and drying. While unwinding the fishing line from the fishing reel it is often forced to through special cleaning pads, and then rinsed in water. There are special cleaning pads on the market that are attached to the fishing rod that make this cleaning process easier. The objective of this invention to provide a simple low cost water powered storage reel that automatically unwinds the fishing line from the fishing rod and reel, while at the same time washing or desalinating the fishing line with a continuous water spray.

### SUMMARY OF THE INVENTION

This invention relates to a water powered fishing line washing apparatus that is connected to a domestic water source and used in conjunction with a fishing rod and reel. The fishing line from the fishing rod is attached to the apparatus storage reel, and the fishing line is automatically washed by allowing the line to wind onto the apparatus storage reel from the fishing rod and then rewinding the line back onto the fishing rod using the fishing rod reel. The apparatus includes a storage reel hub with a plurality of posts radially spaced and axially aligned in pairs of posts that are secured to the said hub, thereby providing means for containing the fishing line when it is wound onto the hub between the axially aligned posts. The said posts have a internally drilled blind hole and an exit hole crossed drilled into the internal hole near the blind end. The reactive force resulting from water exiting the exit holes on the said posts rotate the storage reel with sufficient power to unwind the fishing line from a fishing rod and reel. The hand operated fishing line reel on the rod can easily overpower the water powered storage reel and rewind the fishing line back onto the rod reel. The pairs of axially aligned holes on the posts are oriented so that the water streams from the exit hole impinge on each other to form a spray pattern confined to the perimeter of the storage reel. During the unwinding and rewinding of the fishing line from the rod, the line and storage spool is continuously sprayed with water.

The fishing line can be thoroughly washed or desalinated by repeatedly allowing the storage reel on the apparatus to unwind the line from the fishing rod reel, and then hand rewinding the line back onto the reel. The water powered storage reel rotates on a spindle which is an integral part of a support stand with a water inlet valve connection. The spindle has water porting and water distributing grooves, which supply water continuously to the water powered storage reel. The speed of rotation is accomplished by adjusting the water flow rate with a control valve.

### DETAILED DESCRIPTION OF THE INVENTION

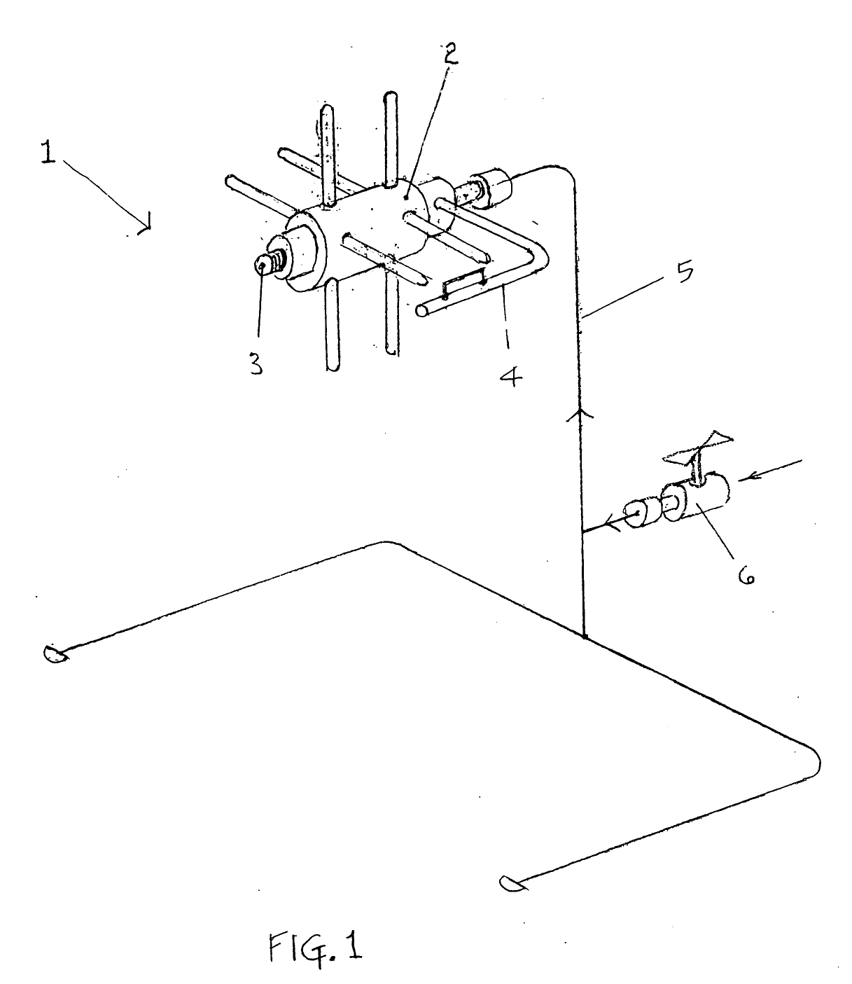

Referring to FIG. 1 the water powered fishing line washing apparatus designated by the numerable (1) consists of a removable storage reel (2), a spindle (3), a fishing line guide (4), a tubular supporting stand. (5) and a water connection control valve (6).

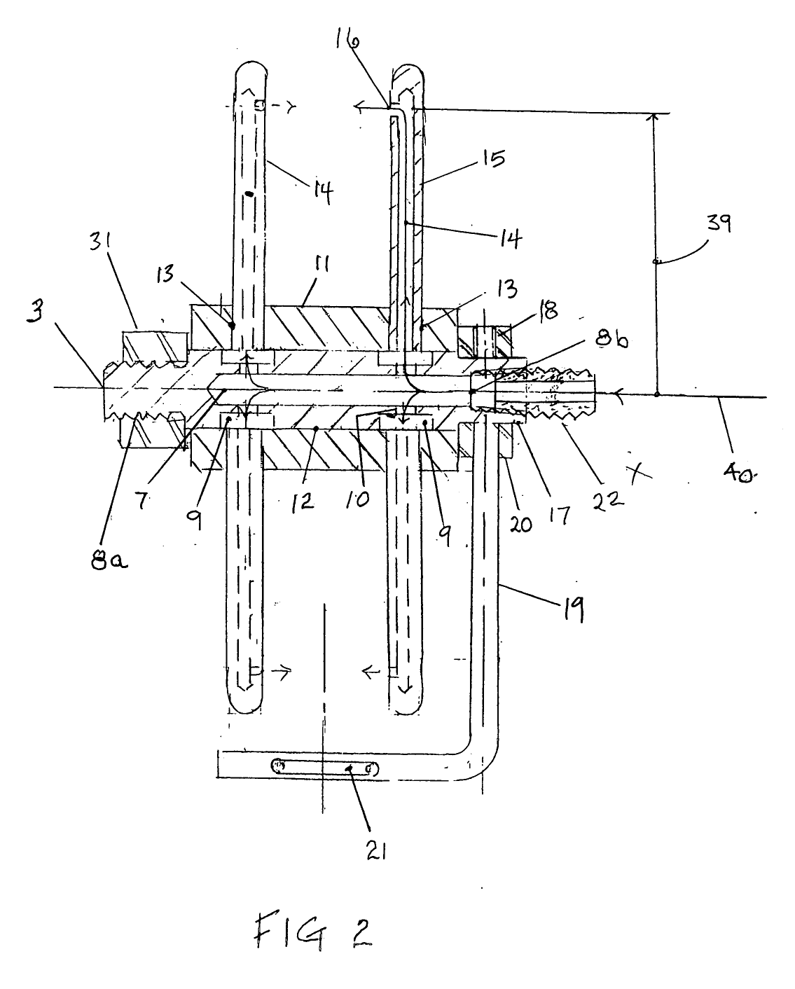

Referring to FIG. 2 the spindle (3) has a centrally drilled blind hole (7) with a pipe tap (8a) at the open end of the blind hole (7). The spindle (3) has two annular grooves (9) near each end of the spindle (3) and holes (10) drilled through the spindle (3) on the centerline of the two annular grooves (9). The blind hole (7), the holes (10) and the annular grooves (9) provide a fluid path from the spindle (3) to the storage reel ( 2). A pipe nipple (22) is screwed into the pipe tap (8) in the spindle (3), thereby providing a fluid connection to the to the tubular support stand (5).

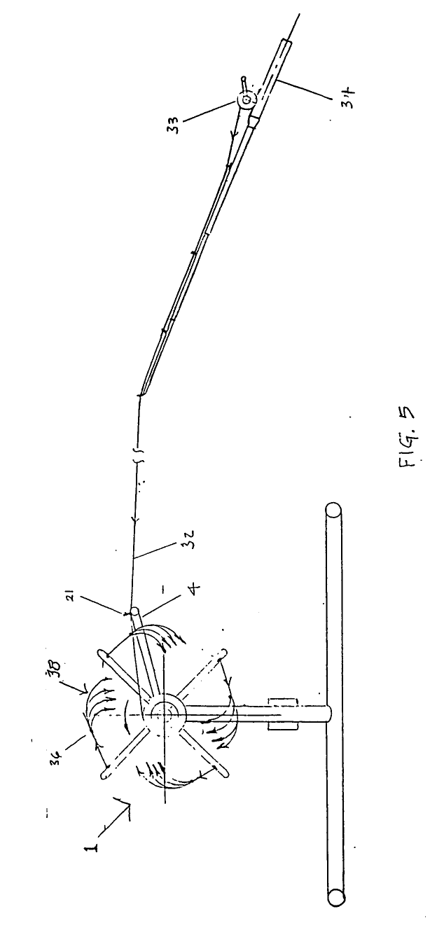

Referring to FIG. 1, FIG. 2 and FIG. 5 the storage reel (2), consists of a hub (11) with a center bore (12) and a plurality of pairs of radially, and axially aligned, equally spaced holes (13) are drilled into the hub (11). The said pairs of posts (15) are inserted into and secured in the said pairs of axially aligned holes (13) in the hub (11), thereby defining a fishing line storage reel 2, with the space between the four pairs of posts (15) providing containment of the fishing line when it is wound onto the storage reel (2). The posts (15) have a concentric blind hole (14) drilled into them. An exit hole (16) is drilled from one side of the post (14) into and near the end of the of the blind hole (15). The fishing line guide (4) is slid over the shouldered diameter (17) of the spindle (3) and secured to the spindle by a set screw (18). The fishing line guide (4) consists of a rod (19) with a ninety degree bend, a collar (20) attached at one end and an eyelet (21) attached to the other end of the bent rod (19). The eyelet (21) is positioned and attached to the rod (19) so that it is centered between the posts (15) on the reel (2), thereby providing means for guiding a fishing line (32) onto the storage reel (2) as it is unwound or rewound onto a fishing pole reel (33) of a fishing pole (34).

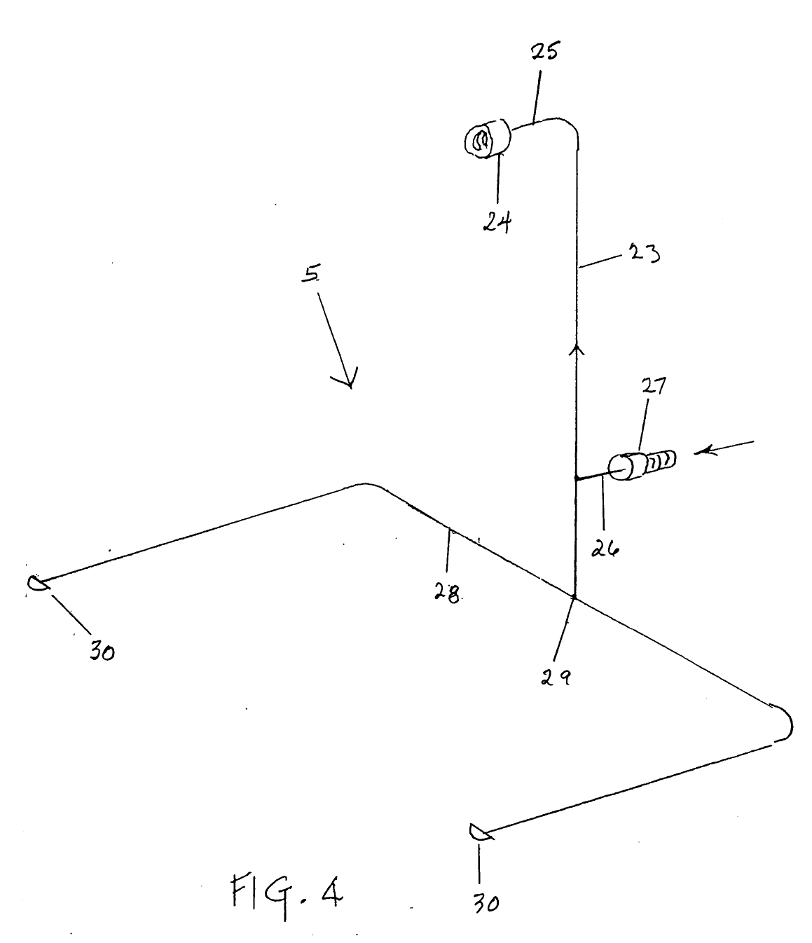

Referring to FIG. 1 and FIG. 4 a tubular weldment (5) consisting of a vertical ell shaped tubular section (23) with a female pipe adapter (24) welded to the horizontal leg (25) and a horizontal inlet tube (26) with a male pipe adapter (27) welded on to one end of the inlet tube (26). The horizontal inlet tube (26) is welded to the vertical ell tubular section (23) at a point near the end of the vertical leg of the ell shaped tubular section (23), thereby forming a water inlet tee connection. The vertical ell tubular section (23) is welded on to a horizontal U shaped tubular section (28) at its mid point (29) and perpendicular to the horizontal plane formed by the shaped tubular section (28). The ends of the shaped tubular section (28) are sealed with end caps (30), thereby forming a stable supporting stand and a water supply conduit to the spindle (3) and storage reel (2).

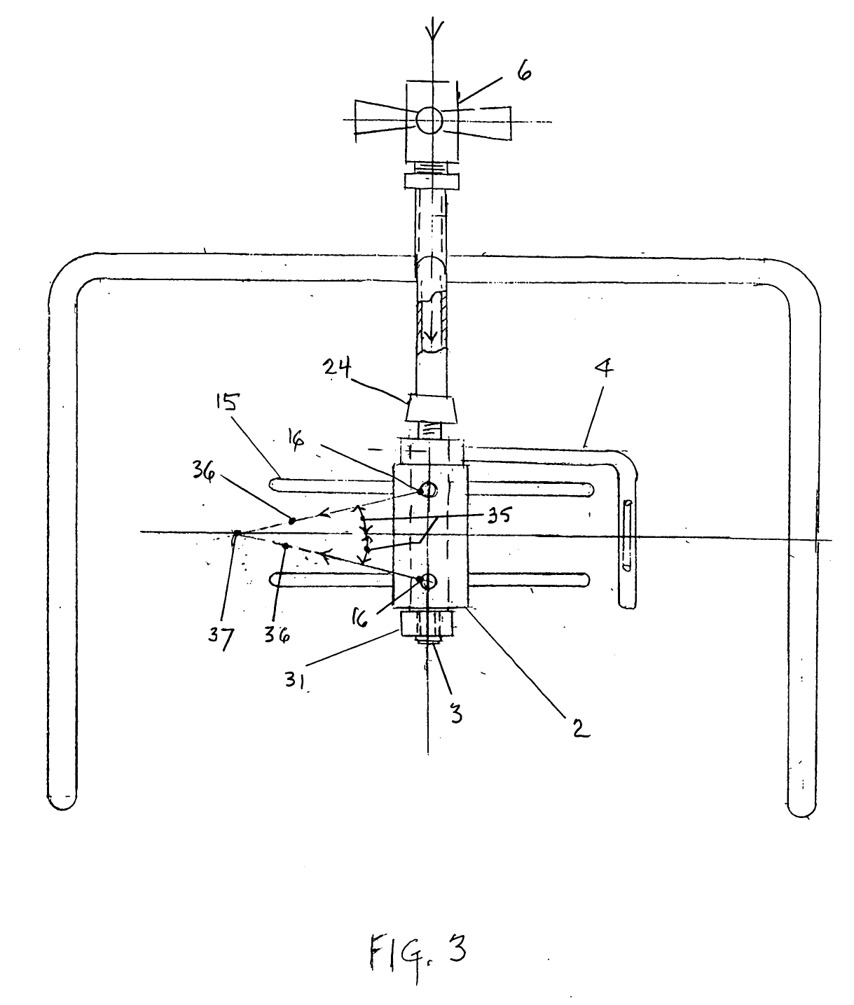

Referring to FIG. 3 and FIG. 4 the nipple (22) in the pre assembled spindle (3) is screwed on to the pipe threaded female adapter (24) on the support stand (5), thereby becoming an integral part of the support stand and providing a rotational axis and supporting stand for the storage reel (2). A knurled knob (31) retains the reel (2) and provides for easy removal and installing of storage reels.

Referring FIG. 3 and FIG. 5 the exit holes (16) in the posts (15) secured in the storage reel (2) are oriented at an angle (35) so that the water streams (36) impinge on each other at a predetermined point (37), thereby providing an effective washing spray pattern (36).

What is claimed:

1. A water powered fishing line washing line apparatus (1) having means for washing and desalinating fishing lines and used in conjunction with a fishing rod and reel, comprising in combination:
(a) A fishing line storage reel (2) consisting of storage reel hub (11) with a bored hole (12) through its central axis, a plurality of pairs of equally spaced radially and axially aligned and opposing holes (13) drilled through opposite ends of said storage reel hub (11), a plurality of posts (15) are fitted and secured into said pairs of equally spaced axially aligned and opposing holes (13), thereby comprising a storage reel (2), said posts (15) have a centrally drilled blind hole (14) and an exit hole (16) drilled into said blind hole (14), from one side of said post (15) and near the end of said blind hole (14), the exit holes (16) on each pair of posts (15) are oriented so that the central axis (36) of the drilled hole (16) on the each pair of opposing posts (15) converge at a predetermined point (37), the said blind holes (14) and exit hole (16), provide means for water to flow from a spindle (3) through the said storage reel (2) and discharging through exit holes (16), thereby providing means for the reactive force resulting from the water exiting each of the said holes (16) to rotating the storage reel.
(b) a spindle (3) said spindle having at one end a reduced threaded extension (8a) and at the opposite end a shouldered diameter (17), a centrally drilled blind hole (7) and an internal pipe thread (8b) at the open end of said blind hole (7), the spindle (3) having relief grooves (9) on the outer diameter of spindle (3) and drilled through holes (10) centered in said relief grooves (9), said grooves (9) and drilled through holes (10) on spindle (3) align and communicate with the radially spaced pairs of holes (14) in the posts (15) secured in the reel hub (11), thereby defining a flow path from the centrally drilled blind hole (7) in spindle (3) through holes (10), grooves (9), blind holes (14) in posts (15) and discharging through exit holes (16) in the posts (15), further defining a flow path,
(c) a knurled knob (31) internally treaded, said knurled knob mates with said threaded reduced diameter extension (8a) on said spindle (3), thereby providing means for positioning and retaining said storage reel (2) on spindle (3),
(d) a fishing line guide (4), consisting of a bent rod (19) formed to intersect the path of a fishing line (32) at a ninety degree angle, a guide rod collar (20) is secured to one end of said rod (19), the said collar (20) is bored to fit onto the said spindle (3) on the shouldered diameter (17) of the spindle (3), a formed wire eyelet (21) is attached to the other end of said rod (19), said wire eyelet (21) is oriented and attached to the rod (19) in a plane perpendicular to the path of the said fishing line (31), thereby providing means to guide a fishing line (32) between the posts (15) and onto the storage reel hub (11),
(e) a storage reel support stand (5), said stand is a formed tubular weldment, consisting of a tubular ell shaped vertical section (23) terminating at one end of said tubular ell shaped vertical section (23) with a female thread adapter (24), a horizontal tubular extension (26) welded onto and near the opposite end of said tubular ell shaped vertical section (23) terminating with a male threaded adapter (27), and a horizontal-U shaped tubular section (28), whereby the said tubular ell shaped vertical section (23) is welded onto the horizontal said tubular shaped section (28) at a central point (29) and perpendicular with the said tubular ell shaped vertical section (23). The said male adapter (24) mates with said spindle (3), thereby providing stable supporting means and an axis of rotation for said storage reel (2), the adapter (27) mates with a water flow control valve (6) and the said horizontal shaped tubular section (28) has the two ends (30) capped off, thereby providing means for containing and directing the water flow from the control valve (6), through the said reel support stand (5) to the said storage reel (2).

2. The storage reel (2) according to claim 1. wherein the exit holes (16) on the posts (15) can be further characterized as to their orientation, whereby the central axis's of the water streams (36) on opposing posts (15) of the said storage reel (2), are oriented at an angle (36) and intersecting at a point (37), thereby providing means for said water streams (36) to impinge upon each other at the said point (37), thereby forming water spray patterns (38).

3. The storage reel (2) according to claim 1. wherein the said exit holes (16) on the said posts (15) can be further characterized as to the mathematically correct and predetermined RADIAL location (39) from the rotational axis (40), thereby providing means for the reactive force produced by the said water streams (36) to rotate the storage reel (2) and wind said fishing line (32) onto storage reel (2).

4. The storage reel (2) according to claim 2. wherein the exit holes (16) on said posts (15) can be further characterized as to their mathematically correct and predetermined ANGLE of orientation (35), thereby providing mean for producing a predetermined spray pattern (38).
